(19) United States
(12) Patent Application Publication
(10) Pub. No.: US 2005/0129971 A1
(43) Pub. Date: Jun. 16, 2005

(54) Transition inserts and methods for joining dissimilar metals

(76) Inventors: Steven W. Ping, Pleasanton, CA (US); Rick James, Spokane, WA (US)

Correspondence Address: John S. Reid;Reidlaw, L.L.C., 1926 S. Valleyview Lane, Spokane, WA, 99212-0157, US

(21) Appl. No.: 10/736,022

(22) Filed: Dec. 15, 2003

(51) Int. Cl. B32B 15/00

(52) U.S. Cl. 428/615; 428/650

(57) ABSTRACT

Transition inserts and methods of joining two dissimilar metals are described. In one implementation a transition insert is described. The transition insert includes a first member comprising essentially steel, a second member comprising Al and between about 1.8% and 10.0% Si. The first member and the second member are joined to one another by roll bonding or explosion bonding. In another implementation the transition insert includes an interlayer which is joined to one of the first member or the second member. In this implementation the first member and the second member are joined to one another at the interlayer by the roll bonding or the explosion bonding. In another implementation, a method of joining two dissimilar metals is described. The method includes bonding a first member comprising essentially steel with a second member comprising Al and between about 1.8% and 10.0% Si.

### TECHNICAL FIELD

The present invention relates to transition inserts and methods for joining dissimilar metals.

### BACKGROUND

Transition inserts are used in a variety of applications to join two dissimilar metals together. For example, transition inserts are used in the manufacturing of aluminum (e.g., in electrolytic reduction cells) to conduct an electrical current into anodes which are located in an aluminum pot. As another example, transition inserts are used in shipbuilding to join a steel substructure (the hull) to an aluminum superstructure. Typically, virtually pure aluminum is used as the aluminum member of such transition inserts.

In higher temperature applications, such as aluminum manufacturing, ultra high temperatures may have deleterious effects on the transition inserts. For example, exposure to ultra high temperatures may lead to a weakening of the transition insert bond, and may ultimately lead to failure of the bond. After some time at the higher temperatures, metal atoms at the bi-metal interface diffuse across the interface. When enough diffusion has occurred, intermetallic phases can form at the interface. If the growth of the intermetallic phase or phases is rapid and extensive, then microscopic voids (or micro-porosity) can form at the leading edge of this rapid intermetallic growth. The micro-porosity can eventually link together creating a zone of weakness and/or deteriorations at the bond, and, in severe cases, can lead to bond separation. Such deleterious effects can be attributed to a metallurgic phenomenon called the “Kirkendall Effect”.

### SUMMARY

Transition inserts and methods of joining two dissimilar metals are described. The embodiments disclosed herein are for illustrative purposes and should not be construed as limiting the invention.

In one embodiment of the present invention a transition insert is described. The transition insert includes a first member comprising essentially steel, a second member comprising Al (aluminum) and between about 1.8% and 10.0% Si (silicon). The first member and the second member can be joined to one another by roll bonding, as well as by other known bonding methods such as explosion bonding.

In another embodiment of the present invention the transition insert can further include an interlayer which is joined to one of the first member or the second member. In this implementation the first member and the second member are joined to one another at the interlayer by the bonding. Exemplary materials for the interlayer can include, without limitation, chromium and titanium.

In a further embodiment of the present invention, a method of joining two dissimilar metals is described. The method includes providing a first member comprising essentially steel, and providing a second member comprising Al and between about 1.8% and 10.0% Si. The first member and the second member are then bonded to one another by a process such as roll bonding or other known bonding processes, such as explosion bonding.

In yet another embodiment of the present invention the transition insert includes a first member comprising essentially steel, a second member comprising Al and between about 1.0% and 1.3% Si. The first and second members are joined to one another by one of roll bonding or explosion bonding.

### DESCRIPTION OF THE DRAWINGS

FIG. 1 is a diagrammatic sectional view depicting a process of joining dissimilar metals in accordance with a first embodiment of the present invention.

FIG. 2 is a diagrammatic sectional view depicting a process of joining dissimilar metals in accordance with a second embodiment of the present invention.

### DETAILED DESCRIPTION

Transition inserts are used to join two dissimilar metals, since traditional fusion welding of many dissimilar metals (e.g., aluminum and steel) is not feasible or does not produce an integral product having the desired strength characteristics. Such transition inserts can be formed by solid state processes such as roll bonding or explosion bonding, which provide a means for making a strong metallurgical bond between dissimilar metals. The transition insert or transition coupling which is thereby formed provides metal surfaces which can then be joined to like-metals by conventional fusion welding processes.

Unfortunately, in higher temperature applications—such as aluminum manufacturing, ultra high temperature exposure can lead to a weakening of the transition insert bond, and can thus decrease electrical conductivity through the transition insert bond, and can ultimately lead to failure of the transition insert bond. Such deleterious effects between metallurgically bonded, dissimilar metals are common due to a phenomenon called the Kirkendall Effect, in which at high temperatures the bond deterioration and/or bond failure is attributed to significant metallic diffusion across the bimetallic interface and the subsequent rapid formation of an intermetallic phase (or phases) and microscopic voids (or micro-porosity) create a zone of weakness at the bond, and can ultimately lead to bond separation. The Kirkendall Effect is a time-temperature sensitive effect, such that the effect occurs more quickly with higher temperatures. In the aluminum manufacturing process, it has been speculated that abnormally high temperatures might exist for long enough periods of time that an intermetallic zone and Kirkendall Effect can occur. Laboratory tests are therefore required by some aluminum manufacturers to demonstrate that a transition insert has adequate strength after a high temperature heat treatment.

In addition to deterioration of the transition insert bond, difficulties may also be experienced when welding transition inserts into place (i.e., while performing conventional fusion welding). For example, in some cases cracks will develop during or following such welding processes. Repairing such cracks often requires that additional welding be performed.

For these and other reasons, it is desirable to develop transition inserts and methods for joining two dissimilar metals which will help to prevent such bond deterioration and/or failure. It is also desirable to develop transition inserts having improved weldability, so that the incidence of cracking during the welding process is decreased. Moreover, it is desirable to develop methods and apparatus which will accomplish these objectives in a convenient and efficient manner. While the present invention is principally directed towards overcoming the above identified issues, the invention is in no way so limited, and is only limited by the accompanying claims as literally worded and appropriately interpreted in accordance with the Doctrine of Equivalents.

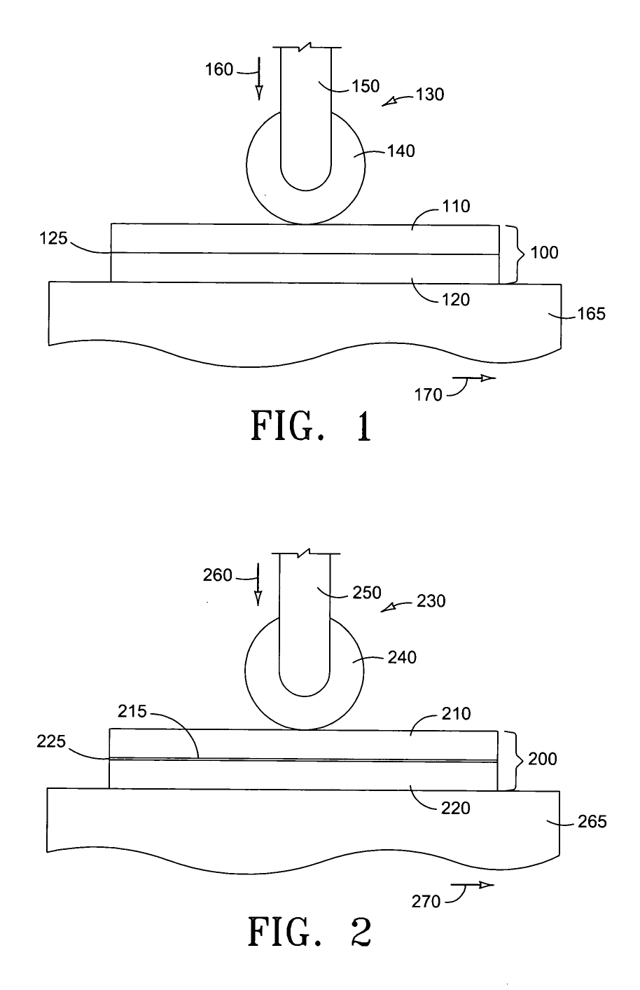

Referring to FIG. 1, a transition insert 100 is depicted in a diagrammatic view. It should be noted that the diagrammatic views presented in FIGS. 1 and 2 are not to drawn to scale in order that the embodiments depicted therein can be more clearly shown. As shown, the transition insert 100 includes a first member 110 comprising essentially steel, and a second member 120 comprising Al (aluminum) and between about 1.8% and 10.0% Si (silicon) by weight. The second member 120 is also referred to herein as the silicon-alloyed aluminum member or the aluminum member of the transition insert 100. In the context of this document, the term “aluminum” refers to elemental aluminum or to any aluminum alloy. The term “essentially steel” refer to any alloy of iron and carbon, containing up to 1.7% carbon as an alloying constituent, and which can include other constituents depending on the desired properties of the alloy. The terms “aluminum-silicon alloy” or “silicon-alloyed aluminum” refer to any alloy of aluminum which contains silicon as an alloying constituent.

In the context of this document, the term “about 1.8% Si” is defined to mean the lowest percentage of Si (greater than 1.5%) which can be added to the Al to produce a transition insert 100 having both good weldability and adequate resistance to cracking. The term “about 10.0% Si” is defined to mean the highest percentage of Si which can be added to the Al to produce a transition insert 100 having adequate ductility.

In some cases the second member 120 which comprises Al can be later welded to a high silicon aluminum alloy (e.g., such as 4043 aluminum alloy which is commonly used), while in other cases the second member 120 can be later welded to commercially pure aluminum (i.e., aluminum that contains little if any Si). In cases in which the second member 120 is to be later welded to a high silicon aluminum alloy, there can be an increased propensity for cracking at the resulting weld-affected zoned, when the resulting weld-affected zone contains certain ranges of Si. This increased propensity for cracking is at its peak when the resulting weld-affected zone contains between about 1.4% and 1.6% Si by weight, and decreases outside of this range.

As depicted in FIG. 1, the first member 110 and the second member 120 are joined to one another by roll bonding at the transition insert bond 125. The roll bonding process is generally indicated by numeral 130. Roll bonding techniques are well known in the art and need not be discussed in detail here. However, for those unfamiliar with the art of roll bonding, the following brief description is provided. In basic terms, two dissimilar pieces of metal (e.g., aluminum and steel plates) are placed in apposition to one another and passed through a rolling mill with sufficient pressure to create bonding between the mating surfaces of the dissimilar metals. In FIG. 1, the first member 110 and the second member 120 are shown being rolled together by a roller 140. In the depicted example, the roller 140 is positioned on the transition insert 100 which is being formed. A shaft 150 is attached to the roller 140 and exerts a downward pressure (as indicated by arrow 160) onto the first member 110 and second member 120 as they are moved past the roller 140. Here, table 165 functions to move the first and second members 110, 120 past the roller 140 during the roll bonding process 130. In FIG. 1, the table 165 moves the first and second members 110, 120 to the right (as indicated by arrow 170). For increased clarity, the roll bonding process 130 depicted utilizes a single roller 140. However, the use of any roll bonding technique, whether now-known or yet-to-be discovered, is contemplated by the present invention.

Transition inserts in accordance with the present invention can be formed by other known bimetallic bonding processes, such as, without limitation, explosion bonding. Once again, such explosion bonding techniques are well know in the art and need not be discussed in detail here. However, for those unfamiliar with the art of explosion bonding, the following brief description is provided. In basic terms, two pieces of dissimilar metal (e.g., aluminum and steel plates) are placed in close contact with one another, and then a controlled detonation of explosives causes one or both of the pieces of metal to accelerate into the other in such a manner as to fuse the two pieces of metal together.

Referring again to FIG. 1, in other implementations, for example when the second member 120 is to be later welded to a high silicon aluminum alloy, various amounts of Si can be added to the second member 120. Adding various amounts of Si will produce transition inserts 100 having various advantageous characteristics. For example, in one implementation, the second member 120 comprises between about 2.0% and 5.0% Si by weight. In the context of this document, the term “about 2.0% Si” is defined to mean the lowest percentage of Si (greater than 1.5%) which is added to the Al to produce a transition insert 100 having adequate resistance to cracking and which is easily formed by roll bonding 130. The term “about 5.0% Si” is defined to mean the highest percentage of Si (in this example) which is added to the Al to produce a transition insert 100 having adequate ductility and which can be formed by roll bonding 130.

In another implementation, in which the second member 120 is to be welded to a high silicon aluminum alloy, the second member 120 comprises between about 2.0% and 3.0% Si by weight. In the context of this document, the term “about 2.0% Si” is defined to mean the lowest percentage of Si (greater than 1.5%) which is added to the Al to produce a transition insert 100 having adequate resistance to cracking and which is easily formed by roll bonding 130. The term “about 3.0% Si” is defined to mean the highest percentage of Si which is added to the Al to produce a transition insert 100 having adequate resistance to cracking and which is readily formed by roll bonding 130.

Referring still to FIG. 1, in other implementations lower amounts of Si can be added to the second member 120. For example lower amounts of Si can be added to the second member 120 when the second member 120 is not to be later welded to a high silicon aluminum alloy. For example, when the second member 120 is to be welded to commercially pure aluminum or when welding is not an issue. In one implementation, the second member 120 comprises between about 1.0% and 1.3% Si by weight. In the context of this document, the term “between about 1.0% and 1.3% Si” is defined to mean the smallest percentage of Si (less than 1.5%) which can be added to the Al to produce a transition insert having adequate resistance to cracking.

In relatively high temperature (i.e., 250 degrees C. and above) aluminum manufacturing processes, transition inserts are commonly used for joining an aluminum member (e.g., aluminum bus systems) and a steel assembly (e.g., for holding carbon anodes in place or for joining steel current-carrying cathode members to the bus). Typically, in such processes, the anode is suspended within a pot of molten electrolyte used to reduce aluminum ore. When a transition insert is used in this way, a primary concern is to ensure both the electrical continuity and the strength of the aluminum member, so that the aluminum member can conduct electrical current and support the weight of the anode. Thus, heretofore, essentially pure aluminum has been used for such aluminum members. Silicon-alloyed aluminum members (such as 120) have not been used in such applications since the use of such an alloy would complicate the bonding process, and was not perceived to provide other advantages.

More specifically, prior art transition inserts which have been used in aluminum manufacturing processes have not employed aluminum members alloyed with silicon (such as second member 120), since silicon is known to lower the melting point of the aluminum member.

However, we have discovered that the Kirkendall Effect becomes a factor long before the melting point of the silicon-alloyed aluminum member 120 becomes a concern. That is, even though the melting point of the aluminum member 120 of a transition insert 100 will be slightly lowered by adding silicon to the aluminum member 120, the benefits of slowing or eliminating the Kirkendall Effect by adding the indicated amounts of silicon to the aluminum member 120 outweighs any detrimental effects which are experienced as a result of the lowered melting point.

Contrary to prior art conventional wisdom, we have discovered that by adding selected amounts of silicon to the aluminum member 120, a transition insert 100 having overall increased durability can be formed. Moreover, the overall tensile strength of such a transition insert 100 is increased over a wide range of temperatures (i.e., from cold to melting), when compared to the tensile strength of prior transition inserts having aluminum members which are made of essentially pure aluminum. In addition, the overall tensile strength of such a transition insert 100 is also increased over a wide range of temperatures (i.e., from cold to melting), when compared to the tensile strength of transition inserts having non-interlayer bonding, and also when compared to the tensile strength of transition inserts having aluminum members which are made of essentially pure aluminum and which include a chrome interlayer.

We have found that although the addition of silicon to the aluminum member 120 can lower the melting point of the aluminum member 120, this decrease in the melting point is irrelevant in practice (as discussed above), and that the transition insert 100 has increased durability at high temperatures.

In addition, prior art transition inserts which are used in aluminum manufacturing processes have not employed aluminum members alloyed with silicon (such as 120) since the addition of silicon can decrease the electrical conductivity of the aluminum member. However, we have found that although the addition of silicon to the aluminum member 120 can slightly decrease the electrical conductivity of the aluminum member 120, this small decrease in electrical conductivity is insignificant, particularly as compared to the increase durability at high temperatures gained by the addition of selected amounts of silicon to the aluminum member 120.

Additionally, the use of a silicon-alloyed aluminum member 120 in a transition insert 100 is contrary to conventional wisdom since a silicon-alloyed aluminum member 120 requires higher pressures to be roll bonded than does an essentially pure aluminum member. However, we have found that by using adequate roll bonding pressures (i.e., enough pressure to exceed the yield strength of the silicon-alloyed aluminum, so that the silicon-alloyed aluminum will bond with a dissimilar metal), aluminum members 120 alloyed with the ranges of silicon indicated herein can be successfully bonded to steel (such as first member 110) or other alloys, without a substantial risk of cracking the aluminum member 120 during the roll bonding process 130. By way of example, about 100 MPa (14 Ksi) can typically be applied during the roll bonding process 130 to bond the silicon-alloyed aluminum member 120 and the first member 110.

Further, in low temperature applications (i.e., typically below 250 degrees C.) of transition inserts (e.g., such as ship building), prior art methods have been concerned with providing transition inserts having an aluminum member that is compatible with welding to secondary aluminum components. In such cases, the tendency has been to use an essentially pure aluminum member in the transition insert, along with a compatible weldment (e.g., weld rod) to join the aluminum member of the transition insert with the secondary aluminum component. The primary concern has thus been directed towards the joint or transition insert bond 125 between the aluminum member 120 and the ferrous (steel) member (i.e., the first member 110) of the transition insert 100, with secondary consideration being given to the weldment between the aluminum member 120 of the transition insert 100 and the secondary aluminum component. This concern has been previously addressed by providing an interlayer (e.g., titanium) between the aluminum member and the ferrous (steel) member of the transition insert. We have discovered that by providing a silicon-alloyed aluminum member 120 as part of the transition insert 100 the overall strength of the transition insert 100 is increased, and a stronger overall joint is made.

The use of the described silicon-alloyed aluminum (as the second member 120) in the manufacture of a transition insert 100 has provided several surprising results. First, the temperature tolerance of the transition insert bond 125 is increased when the silicon-alloyed aluminum member 120 is used. Also, the strength of the bond 125 is maintained for an extended period of time. Further, experimental results show that the use of the silicon-alloyed aluminum member 120 slows migration of iron (from the first member 110) and migration of aluminum (from the second member 120) across the bond 125 at high temperatures. For example, the maximum temperature at which the transition insert 100 can be used without significant bond 125 deterioration is increased by approximately 10% or more. The use of the silicon-alloyed aluminum member 120 thus diminishes the deleterious effects of the Kirkendall Effect to yield a higher temperature limit before the bond zone is negatively affected.

Second, the weldability of the transition insert 100 is improved in many circumstances by using the described silicon-alloyed aluminum member 120. To achieve improved weldability the amount of silicon added to the aluminum member 120 can be varied depending on whether the transition insert 100 is to be later welded to a high silicon aluminum alloy, to a commercially pure aluminum, or to another aluminum alloy. In order to achieve improved weldability, one goal is to keep the level of silicon in the aluminum member 120 above or below a range where the propensity for cracking is increased. For example, when the heat affected zone in a weld transitions from low silicon to moderate or high silicon, the areas where between about 1.4% and 1.6% silicon by weight is found will be at peak propensity for cracking. By keeping the percentage of silicon in the silicon-alloyed aluminum member 120 well above this range (e.g., 1.8% to 10.0%), the propensity for cracking in the zone between parent aluminum (i.e., the silicon-alloyed aluminum member 120) and high silicon weldment can be avoided. This technique makes it much easier for an average field welder to achieve solid, non-cracking welds in a production environment. Accordingly, when the aluminum member 120 of a transition insert in accordance with the present invention is to be later welded to an essentially pure aluminum secondary member, the amount of silicon in the aluminum member 120 is in the range of between about 1.0% and 1.3% Si.

Moreover, the overall tensile strength of the transition insert 100 having a silicon-alloyed aluminum member 120 is improved, as compared to prior transition inserts which utilize commercially pure aluminum members. The overall tensile strength of any transition insert is generally determined by the weaker metal of the transition insert. Generally, in tensile strength testing, the weaker metal (typically the aluminum member) fails in an area near the transition insert bond. Adding silicon as an alloying agent to the aluminum member 120 of the transition insert 100 strengthens the aluminum member 120, and increases the overall tensile strength of the transition insert 100.

When the silicon-alloyed aluminum member 120 contains enough silicon to overcome the cracking problem described above, the transition insert 100 has a characteristic room temperature strength that is 20% to 30% higher than prior art transition inserts. In this case, a prior art transition insert will fail at about 9 Ksi, (e.g., for a 1050 to 1100 series aluminum member) whereas tests of the transition insert 100 of the present invention indicate that the transition insert 100 will fail at about 12 to 13 Ksi.

The use of this silicon-alloyed aluminum member 120 has also significantly increased the high temperature stability of the described transition inserts 100. For example, by using the described aluminum-silicon alloy in the production of such transition inserts 100, the detrimental growth of intermetallic compounds (such as FeAl₃) was not found to be significant until the eutectic melting point of the aluminum alloy (i.e., 577 degrees C.) had been exceeded for some hours.

The tensile properties of transition inserts 100 using various aluminum-silicon alloys have been tested and compared to the tensile properties of prior transition inserts which utilize an aluminum member of commercially pure aluminum. The test results described below utilized a tensile bar design and testing procedure set by “Pechiney” (Groupe Pechiney, 75218 Paris Cedex 16, France).

First, tensile testing of prior transition inserts having a commercially pure aluminum member (such as a 1050 to 1100 series aluminum member) is described. The as-bonded strength of the aluminum member was 210 MPa (30.4 Ksi). After 24 hours at 500 degrees C. the ultimate tensile strength of the aluminum member was 155 MPa (22.4 Ksi). While after 24 hours at 550 degrees C. the ultimate tensile strength of the aluminum member was essentially zero.

For transition inserts 100 utilizing an aluminum alloy containing 2.0% Si by weight, the as-bonded strength was 230 MPa (33.3 Ksi). After 24 hours at 500 degrees C. the ultimate tensile strength for the aluminum alloy containing 2.0% Si by weight was 185 Mpa (26.8 Ksi). While after 24 hours at 550 degrees C. the ultimate tensile strength for the aluminum alloy containing 2.0% Si by weight was 125 Mpa (18.1 Ksi).

For transition inserts 100 utilizing an aluminum alloy containing 3.0% Si by weight, the as-bonded strength was 285 Mpa (41.3 Ksi). After 24 hours at 500 degrees C. the ultimate tensile strength for the aluminum alloy containing 3.0% Si by weight was 225 Mpa (37.6 Ksi). While after 24 hours at 550 degrees C. the ultimate tensile strength for the aluminum alloy containing 3.0% Si by weight was 150 Mpa (21.7 Ksi).

As shown by the test results described in detail above, each of the transition inserts 100 having silicon-alloyed aluminum members 120 demonstrated increased tensile strength as compared to the prior transition inserts having commercially pure aluminum members (e.g., a 1050 to 1100 series aluminum member).

In the previously described implementations, which were described with reference to FIG. 1, the first member 110 and the second member 120 are directly joined to one another at the transition insert bond 125 by roll bonding 130 or other known bonding methods. However the present invention also contemplates the use of one or more interlayers which can be present between the first and second members 110, 120. Such interlayer(s) can comprise any appropriate material(s), and can be joined to either the first member 110 or the second member 120 prior to roll bonding 130. For example, the interlayer can comprise chromium (Cr), titanium (Ti), or any other appropriate material.

Referring now to FIG. 2, an embodiment having an interlayer 215 is described. As depicted, the transition insert is generally indicated by the numeral 200. The transition insert 200 includes the interlayer 215 which is joined to one of the first member 210 or the second member 220. The first member 210 and the second member 220 are joined to one another at the interlayer 215 by roll bonding or by other know bonding processes, such as explosion bonding. Here the interlayer 215 is located at the transition insert bond 225. Preferably, the material of the interlayer 215 is selected to slow the diffusion between the material of the first member 210 and the material of the second member 220 at anticipated operational temperatures of the transition insert 200.

The roll bonding process is generally indicated by numeral 230. As discussed above with reference to FIG. 1, such roll bonding techniques are well known in the art and need not be discussed in detail here. Here, the first member 210 and the second member 220 are shown being rolled together by roller 240. In FIG. 2, the depicted roller 240 is positioned on the transition insert 200 which is being formed. A shaft 250 is attached to the roller 240 and exerts a downward pressure (as indicated by arrow 260) onto the first member 210, the second member 220, and the interlayer 215 as they are moved past the roller 240. Here table 265 functions to move the first and second members 210, 220 past the roller 240 during the roll bonding process 230. In FIG. 2, the table 265 moves the first and second members 210, 220 to the right (as indicated by arrow 270). For increased clarity, the roll bonding process 230 depicted utilizes a single roller 240. However, as described above with reference to FIG. 1, the use of any roll bonding technique, whether now-known or yet-to-be discovered, is contemplated by this invention, as well as other bimetallic bonding techniques (such as explosion bonding).

As described above, the interlayer 215 can comprise any appropriate material. For example, in one implementation the interlayer 215 comprises Cr (chromium). The addition of the chromium interlayer 215 can be accomplished by first joining the interlayer 215 to either the first member 210 or the second member 220. For example, the chromium interlayer 215 can first be electrochemically coated onto a surface of the first member 210 (which comprises essentially steel). After the surface of the first member 210 has been plated with Cr, roll bonding 230 can be performed so that the Cr plated first member 210 and the second member 220 (which comprises Al and between about 1.8% and 10.0% Si) are joined to one another at the interlayer 215.

In this implementation, the provision of the chromium interlayer 215 offers at least two advantages. First, the chromium interlayer 215 helps keep the steel (of first member 210) from oxidizing during preheating, and thus facilitates effective roll bonding. Second, the chromium interlayer 215 significantly slows the diffusion of Al (from the second member 220) and Fe (from the first member 210) across the interlayer 215 at elevated temperatures. For example, if the transition insert 200 is to be heated to more than 300 degree C., the chromium interlayer 215 is useful in slowing diffusion of Al and Fe across the interlayer 215. If the transition insert 200 is not heated to more than 300 degrees C., the chromium interlayer 215 may not offer such an advantage.

Bonded tri-metals (such as transition insert 200 having interlayer 215) can be formed by any suitable method, and the interlayer 215 can therefore be formed to various thicknesses. For example, in one implementation the interlayer 215 is between about 0.01 and 10.0 microns thick. Bonded tri-metals (such as transition insert 200) can be formed using any suitable tri-cladding process. By way of example, and not by way of limitation, bonded tri-metals can be formed using thin film technologies (such as electroplating, plasma coating, and sputter coating), and/or through the use of sheet or foil interlayers.

Another embodiment is now described with reference to FIG. 2. Here the transition insert 200 includes a first member 210, which is a material selected from the group consisting of essentially copper, essentially titanium, and essentially an iron based alloy. In the context of this document, the term “essentially an iron based alloy” refers to cast iron, wrought iron, and to elemental iron including any other alloying constituent. The term “essentially copper” refers to elemental copper and to elemental copper including any other alloying constituent. The term “essentially titanium” refers to elemental titanium and to elemental titanium including any other alloying constituent.

Methods of joining two dissimilar metals are also contemplated by this invention. Such methods are now described with reference to FIG. 2. In one embodiment, the method includes providing a first member 210 comprising essentially steel, and providing a second member 220 comprising Al and between about 1.8% and 10.0% Si. After the first and second members 210, 220 have been provided, the method includes bonding the first member 210 and the second member 220 to one another at the transition insert bond 225. The bonding can be performed by, for example, roll bonding or explosion bonding.

The method can also include providing a second member 220 which comprises various amounts of silicon. For example, in one variation, the method includes providing a second member 220 which comprises between about 2.0% and 5.0% Si. In another variation the method includes providing a second member 220 which comprises between about 2.0% and 3.0% Si. In yet another variation the method includes providing a second member 220 which comprises about 2.0% Si.

In one embodiment the method also includes the steps of providing an interlayer 215 comprising Cr, and then joining the interlayer 215 to one of the first member 210 or the second member 220. In this case, the roll bonding 230 (or other bonding technique) joins the first member 210 and the second member 220 to one another at the interlayer 215.

In other implementations the methods also include providing interlayers 215 of various thicknesses. For example, in one implementation the interlayer 215 provided is between about 0.01 and 10.0 microns thick.

Other methods consistent with the present invention can also be performed. While the exemplary methods described above may recite respective steps and orders of execution, it is to be understood that other suitable methods including other steps and/or orders of execution can also be used. While the above methods and apparatus have been described in language more or less specific as to structural and methodical features, it is to be understood, however, that they are not limited to the specific features shown and described, since the means herein disclosed comprise preferred forms of putting the invention into effect. The methods and apparatus are, therefore, claimed in any of their forms or modifications within the proper scope of the appended claims appropriately interpreted in accordance with the Doctrine of Equivalents.

1. A transition insert, comprising:
a first member comprising essentially steel;
a second member comprising Al and between about 1.8% and 10.0% Si; and wherein,
the first member and the second member are joined to one another by one of roll bonding or explosion bonding.

2. The transition insert of claim 1, wherein the second member comprises between about 2.0% and 5.0% Si.

3. The transition insert of claim 1, wherein the second member comprises between about 2.0% and 3.0% Si.

4. The transition insert of claim 1, further comprising:
an interlayer joined to one of the first member or the second member; and wherein,
the first member and the second member are joined to one another at the interlayer by the roll bonding or the explosion bonding.

5. The transition insert of claim 4, wherein the interlayer comprises essentially Cr.

6. The transition insert of claim 4, wherein the interlayer is between about 0.01 and 10.0 microns thick.

7. A transition insert, comprising:
a first member comprising essentially steel;
a second member comprising Al and between about 1.8% and 10.0% Si;
an interlayer comprising essentially Cr joined to one of the first member or the second member; and wherein,
the first member and the second member are joined to one another at the interlayer by one of roll bonding or explosion bonding.

8. The transition insert of claim 7, wherein the second member comprises between about 2.0% and 5.0% Si.

9. The transition insert of claim 7, wherein the second member comprises between about 2.0% and 3.0% Si.

10. The transition insert of claim 7, wherein the interlayer is between about 0.01 and 10.0 microns thick.

11. A transition insert, comprising:
a first member, wherein the first member is a material selected from the group consisting of essentially copper, essentially an iron based alloy, and essentially titanium;
a second member comprising Al and between about 1.8% to 10.0% Si; and wherein,
the first member and the second member are joined to one another by one of roll bonding or explosion bonding.

12. The transition insert of claim 11, wherein the second member comprises between about 2.0% and 5.0% Si.

13. The transition insert of claim 11, wherein the second member comprises between about 2.0% and 3.0% Si.

14. The transition insert of claim 11, further comprising:
an interlayer joined to one of the first member or the second member; and wherein,
the first member and the second member are joined to one another at the interlayer by the roll bonding or the explosion bonding.

15. The transition insert of claim 14, wherein the interlayer comprises essentially Cr.

16. The transition insert of claim 14, wherein the interlayer is between about 0.01 and 10.0 microns thick.

17-25. (canceled)
